(19) United States
(12) Patent Application Publication
(10) Pub. No.: US 2017/0371849 A1
(43) Pub. Date: Dec. 28, 2017

(54) IN-LINE EDITOR INSERTION

(71) Applicant: HEWLETT PACKARD ENTERPRISE DEVELOPMENT LP, Houston, TX (US)

(72) Inventors: Elad Levi, Yehud (IL); Avigad Mizrahi, Yehud (IL); Ran Bar Zik, Yehud (IL)

(21) Appl. No.: 15/543,335

(22) PCT Filed: Jan. 22, 2015
(86) PCT No.: PCT/US2015/012455

§ 371 Date: Jul. 13, 2017

(51) Int. Cl. G06F 17/22; G06F 9/44; G06F 17/24

(52) U.S. Cl. CPC G06F 17/227; G06F 17/24; G06F 8/36; G06F 17/2247

(57) ABSTRACT

In one example in accordance with the present disclosure, a method for in-line editor insertion includes accessing code for an application that is capable of presenting a front-end page to a user, where content on the front-end page is editable via a back-end editing page. The method includes automatically modifying the code to create a modified application that is capable of presenting a modified front-end page to the user that is similar to the front-end page and where content on the modified front-end page is editable in-line via the modified front-end page.

### BACKGROUND

Various applications (e.g., web applications) are capable of presenting a front-end page to a user where the front-end page displays a number of page elements (e.g., a title, a body, a status image, etc.), each displaying some content (e.g., text, image, etc.). The content on such a front-end page may be editable (e.g., by a privileged user) using a back-end editing page.

### BRIEF DESCRIPTION OF THE DRAWINGS

The following detailed description references the drawings, wherein:

FIG. 1 shows an example front-end editing page and an associated back-end editing page;

FIG. 2 is a block diagram of an example system for in-line editor insertion;

FIG. 3 is a flowchart of an example method for in-line editor insertion;

FIG. 4 is a flowchart of an example method for in-line editor insertion;

FIG. 5 is a block diagram of an example system for in-line editor insertion; and

FIG. 6 is a block diagram of an example system for in-line editor insertion.

### DETAILED DESCRIPTION

As mentioned above, various applications (e.g., web applications) are capable of presenting a front-end page to a user where the front-end page displays a number of page elements (e.g., a title, a body, a status image, etc.), each displaying some content (e.g., text, image, etc.). As one example, a blogging application may present a front-end page to a reader that shows a blog post. The page may include page elements such as the blog post title, the blog post body and an image that shows the status of the blog post (e.g., low, medium high priority). The content displayed via each of these page elements may be editable (e.g., by a privileged user) using a back-end editing page. In other words, the privileged user may need to navigate (e.g., via a web browser) to a different page from the front-end page, modify the content (e.g., using back-end editing interfaces associated with the front-end page elements), save the changes, and then refresh the front-end page to see any changes. Navigating to a different back-end page to perform edits can be cumbersome and inefficient, among other drawbacks.

Some applications are capable of presenting a front-end page to a user similar to the front-end page described above. However, in these applications, the front-end page may be editable (e.g., by a privileged user) in-line via the same front-end page. In other words, a user may be able to edit content directly on the front-end page without navigating to a different back-end page. Such a capability makes editing content displayed by an application much simpler, intuitive and user-friendly. However, to add in-line editing capabilities to an application, a developer may need to spend significant time modifying or adding code (e.g., REST and AJAX) to allow privileged users to change content via the same front-end page that displays the content. The developer may need to modify or add code for the front-end page and a back-end page. Once complete, the in-line editing capabilities will work only for the specific application that the developer worked on. In other words, if the developer wanted to add in-line editing capabilities to anther application, the developer would have to recreate this work. Thus, for these applications, the in-line editing capability is application-specific.

The present disclosure describes in-line editor insertion. According to some examples, an in-line editor insertion service may access accessing code for an application that is capable of presenting a front-end page to a user, where content on the front-end page is editable via a back-end editing page. Then, the service may automatically modify the code to create a modified application that is capable of presenting a modified front-end page to the user that is similar to the front-end page and where content on the modified front-end page is editable in-line via the modified front-end page. Here, the term “similar” may mean that the modified front-end page may include the same general page layout and content as the original front-end page, for example, the same page elements, the same content in the page elements, the same navigation or toolbars, etc. However, the modified front-end page has content (e.g., in page elements) that is editable via the same front end page. Thus, the present disclosure describes automatically adding in-line editing functionality to existing applications. Such functionality can be added with minimal development work by a developer because a developer may only need to provide various pieces of information and the service may use this information to insert code into the existing application code that offers in-line editing functionality. The present disclosure describes a service that can automatically modify applications of various platforms and/or coding languages, and is thus, a cross-platform solution.

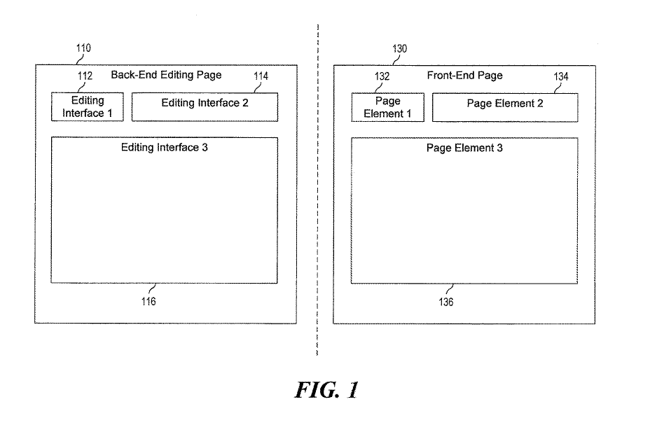

FIG. 1 shows an example front-end editing page 130 and an associated back-end editing page 110. These pages may have been presented by an application (e.g., a web application). The application may, for example, present front-end page 130 to a user, e.g., as a web page displayed in a web browser of the user. Front-end page 130 may display a number of page elements, e.g., page element 1 (132), page element 2 (134) and page element 3 (136). These page elements may be of various types, for example, a body (e.g., page element 3), a title (e.g., page element 2) and a status image (e.g., page element 1). These are just examples used for the purposes of explanation and solutions described here may apply similarly to other types of page elements. Each page element may display some content (e.g., text, image, etc.).

As one particular example, the application referred to above may include a blogging functionality. In this example, front-end page 130 may be a page that shows blog posts. The code that is responsible for displaying front-end page 130 may be executed identically for various different blog posts, and thus, the term “front-end page” may not refer to a specific blog post, but instead a page that displays whatever blog post (e.g., “blog_post_1”, “blog_post_2”, etc.) is indicated by a user. Front-end page 130 may be identifiable by a base URL (e.g., [app]/blog_post), and the particular indicated blog post may be displayed via front-end page 130 when an identifier of the particular blog post is passed to the front-end page. This could be done, for example, by a URL convention where a full URL of [app]/blog_postblogpost_1, for example, calls front-end page 130 to display the blog post with identifier “blog_post_1.” Regardless of which blog post is being displayed, the page elements (e.g., 132, 134, 136) of front-end page 130 may be the same, meaning they retain the same identifiers (e.g., HTML tags, CSS selector, etc.).

Back-end editing page 110 may be similar to front-end page 130 in various respects. For example, back-end editing page 110 may display editing interfaces (e.g., 112, 114, 116) that correspond to the page elements of front-end page 130. These back-end editing interfaces may take various forms. For example, to edit text, a back-end interface may look like an HTML text form, e.g., along with a corresponding “save” button or the like. As another example, to edit an image, a back-end interface may include a drop down selector to select from a number of preselected images, or the back-end interface may include a file selector that allows the user to select a new image from the web or from the user's personal computer.

Continuing on with the particular example of the blogging functionality mentioned above, back-end editing page 110 may be a page that allows for editing of blog posts. The code that is responsible for displaying and operating back-end editing page 110 may be executed identically for various different blog posts, and thus, the term “back-end editing page” may not refer to a specific blog post, but instead a page that allows for editing of whatever blog post (e.g., “blog_post_1”, “blogpost_2”, etc.) is indicated by a user. Back-end editing page 110 may be identifiable by a base URL (e.g., [app]/blog_postledit), and the particular indicated blog post may be loaded via back-end editing page 110 when an identifier of the particular blog post is passed to the back-end editing page. This could be done, for example, by a URL convention where a full URL of [app]/blog_post/blog_post_1/edit, for example, calls back-end editing page 110 to load the blog post with identifier “blog_post_.” Regardless of which blog post is being loaded, the editing interfaces (e.g., 112, 114, 116) of back-end editing page 110 may be the same, meaning they retain the same identifiers (e.g., HTML tags, CSS selector, etc.).

Back-end editing page 110 may allow a user (e.g., privileged user) to make edits to the content of the page elements displayed on front-end page 130. For example, a user may interact with editing interface 1 (112) to modify page element 1 (132), and so on. In some examples, using the back-end editing page 110 may be the only way for a user to modify the content pieces of front-end page 130. However, in such examples, the solutions described herein may access the code of the application and automatically modify the code to create a modified application that is capable of presenting a modified front-end page to the user where content on the modified front-end page is editable in-line via the modified front-end page. This modification may be performed with minimal effort by developer, as described in more detail below.

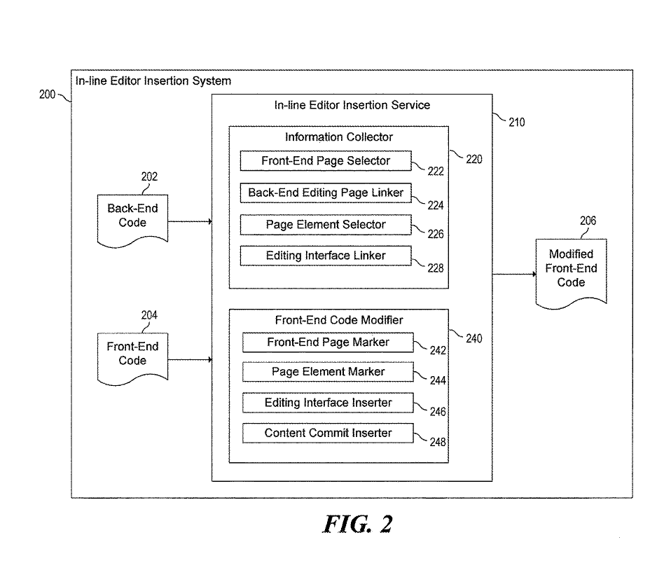

FIG. 2 is a block diagram of an example system 200 for in-line editor insertion. System 200 may include at least one computing device that is capable of running at least one in-line editor insertion service. System 200 may include in-line editor insertion service 210. In-line editor insertion service 210 may access (e.g., via a code accessor) code for an application (e.g., the one mentioned with respect to FIG. 1) that is capable of presenting a front-end page to a user, where content on the front-end page is editable via a back-end editing page. The application may include back-end code 202 related to the back-end editing page and front-end code 204 related to the front-end page. Front-end code 202 and back-end code 204 may each be at least one digital file or other form of stored digital information, for example, containing instructions that may be executed (e.g., by a web browser in the case of a web application) to run at least a portion of the application. Service 210 may access back-end code 202 and front-end code 204. Service 210 may then automatically modify the code (e.g., the front-end code) to create a modified application that is capable of presenting a modified front-end page to a user where content on the modified front-end page is editable in-line via the modified front-end page. As described in more detail below, service 210 may only need to edit the front-end code, and thus, in the example of FIG. 2, service 210 outputs modified front-end code 206. A developer may then be able to implement the modified application by using the same back-end code 202 and modified front-end code 206. In some examples, both back-end code 202 and front-end code 204 may be modified, in which case, service 210 may output modified back-end code and modified front-end code.

In-line editor insertion service 210 may be implemented in various forms. For example, it could be implemented as a plugin to a developer's IDE (integrated development environment) or it could be a standalone application and/or library that allows a user to upload code of an existing application. In-line editor insertion service 210 may include a graphical user interface that allows a user to make various selections and/or inputs mentioned below. Alternatively or in addition, a user may enter various selections into a configuration file of sorts and service 210 may access this information.

In-line editor insertion service 210 may include an information collector 220. Information collector 220 may access or prompt for various pieces of information from a developer. These pieces of information may be saved and used later, e.g., by front-end code modifier 240. Information collector 220 may save this information, for example, in a database or data store that stores digital information. Such a database or data store may include or be in communication with at least one physical storage mechanism (e.g., hard drive, solid state drive, volatile or non-volatile memory, tape drive or the like). These pieces of information may be used to add inline editing capabilities to an existing application. Such capabilities may be added by service 210 with minimal coding or development effort by the developer. Instead, the developer provides (and information collector 220 accesses and saves) various pieces of information. Information collector 220 may include a front-end page selector 222, a back-end editing page linker 224, a page element selector 226 and an editing interface linker 228. Each of these components and information collector 220 in general may each include instructions (e.g., stored on a machine-readable storage medium of system 200) that, when executed (e.g., by a processor of system 200), implement the functionality of the component. Alternatively or in addition, each of these components and information collector 220 in general may include electronic circuitry (i.e., hardware) that implements the functionality of the component.

Front-end page selector 222 may allow a developer to select at least one front-end page that should be in-line editable. For example, a page that displays blog posts as in the example above may be selected. Front-end page selector 222 may save this selection (i.e., the type of page), for example, by saving an indicator of this page type. For example, a URL extension (e.g., “/blog_post” if full URL was [app]/blog_post/[particular blog post]) of this page could be saved. Alternatively, an HTML tag of the page could be saved, for example, “blog_post” if the page had an HTML tag of <html class=“blog_post”>. Alternatively, if CSS tags were used to identify the page type, such a CSS tag could be saved. Front-end page selector 222 or the developer via front-end page selector 222 may try to save an indicator of the selected page that already exists (e.g., an existing portion of the URL, an existing HTML tag, etc.). If this will not work for some reason, front-end page selector 222 may create a new identifier and save it, and that identifier may be added to the selected page later (e.g., via front-end page marker 242). Table 1 below shows more details of information that maybe saved by front-end page selector 222.

Back-end editing page linker 224 may allow a developer to select, for each selected front-end page (i.e., page type), a back-end editing page that should be linked to the front-end editing page/page type. The selected back-end editing page may be the existing back-end editing page that an existing application uses to edit content of the front-end page/page type. Back-end editing page linker 224 may save this selection (i.e., the back-end editing page that is used to edit content of the associated page type), for example, by saving an indicator of this back-end editing page. For example, a URL extension (e.g., “/blog_post/[particular blog post]/edit” if full URL was [app]/blog_post[particular blog post]/edit) of this page could be saved. Alternatively, an HTML tag of the page could be saved, for example, “blog_post_editor” if the page had an HTML tag of <html class=“blog_post_editor”>. Alternatively, if CSS tags were used to identify the page type, such a CSS tag could be saved. Table 1 below shows more details of information that maybe saved by back-end editing page linker 224.

Page element selector 226, for each front-end page (i.e., page type) that was selected to be editable (see above), may allow a developer to select at least one page element (e.g., 132, 134, 136 of FIG. 1) of the page that should be in-line editable. Page element selector 226 may save these selections, for example, by saving a CSS selector or HTML tag of each page element. Table 2 below shows more details of information that maybe saved by page element selector 226. Thus, in effect, page element selector 226 allows the developer to create a list of specific page elements that should be in-line editable.

Editing interface linker 228 may, for each page element of a front-end page that is selected to be in-line editable, allow the developer to select a corresponding back-end editing interface (e.g., 112, 114, 116 of FIG. 1). Editing interface linker 228 may save these selections, for example, by saving a CSS selector or HTML tag (e.g., “name” attribute or element ID) of each back-end editing interface. Table 2 below shows more details of information that maybe saved by editing interface linker 228. Thus, editing interface linker 228 creates a connection between each selected front-end page element and a corresponding editing interface (e.g., that already exists in the application to allow back-end editing of the page element). These connections may be used later (e.g., by front-end code modifier 240) to insert in-line editing functionality for these page elements that allows changes to be sent to the corresponding back-end editing interfaces.

Tables 1 and 2 below show a summary of example information that may be collected and saved by information collector 220.

Table 1:

TABLE 1

| Page Type Name | Back-end Editing Page | Front-end Page/Page Type Identifier |
|---|---|---|
| blog_post | /blog_post/[particular blog post]/edit | /blog_post/[particular blog post] (URL extension) |
| | Or | Or |
| | blog_post_editor (e.g., html class = “blog_post_editor”) | blog_post (e.g., html class = “blog_post”) |
| news | /news/[particular news story]/edit | /news/[particular news story] (URL extension) |
| | Or | Or |
| | news_editor (e.g., html class = “news_editor”) | news (e.g., html class = “news”) |

As can be seen in Table 1 above, the first row shows example information that information collector 220 may collect for an example blogging page like the one described in more detail above. The first row shows an example page type name (“blog_post”) and also shows how the front-end page may be identified and recorded of being of this page type. The first row also shows how, for the front-end page type of “blog_post,” a particular back-end editing page may be identified and recorded. Thus, Table 1 saves information that may be used to connect the blogging front-end page to the appropriate back-end editing page.

It should be understood that “blog_post” is just one example page type and other page types may be supported as well, even within the same application. Table 1 above, in the second row, shows another example of a “news” page type. Like the blog_post page type, this information connects the news front-end page to the appropriate back-end editing page. Information collector 220 may collect more information than is shown in Table 1, for example, for more page types (e.g., product information pages, user profile pages, etc.). Each page type may generally be associated with a type of content, but this is not required. For example, two different page types may both be relate to displaying news, e.g., in different formats.

The example of Table 2 below shows example information that information collector 220 may collect for an example blogging page like the one described in more detail above. Thus, Table 2 shows additional information that may be collected for that particular page type. Similar information may be collected for other page types such as a “news” page type.

TABLE 2

| Back-end Editing Interface | Front-end Containing element |
|---|---|
| edit_body | blog_post_body |
| (e.g., textarea name= “edit_body”) | (e.g., div class=“blog_post_body” |
| | or h2 id=“blog_post_body”) |
| edit_title | blog_post_title |
| (e.g., textarea name= “edit_title”) | (e.g., div class=“blog_post_title” |
| | or h2 id=“blog_post_title”) |

As can be seen in Table 2 above, the first row shows an example page element (the body) of the front-end blogging page. Specifically, the body element may be identified, for example, using a CSS selector or HTML tag. In the example above, the body element is identified with a “blog_post_body” ID. Then, it can be seen that information collector 220 also stores a corresponding back-end interface for the body. The back-end interface may be identified by an HTML tag or the like, e.g., a “name” attribute in this example with a “edit_bod” ID. Table 2 also shows another example for another page element (the title). Information collector 220 may store similar information for various other front-end page elements and corresponding back-end editing interfaces.

Front-end code modifier 240 may access the information collected and saved by information collector 220, and may use this information to modify the original code of an original/existing application. Referring again to FIG. 2, the original code may include back-end code 202 and front-end code 204. In the example of FIG. 2, front-end code modifier 240 may only need to modify front-end code 204 in order to inject in-line editing into the application, and thus front-end code modifier may output only modified front-end code 206. This may offer benefits, for example, simplifying the in-line editor insertion because back-end code may stay the same. In some example, back-end code 202 may be modified as well, and this case is contemplated by this disclosure. However, for simplicity, the examples provided herein mainly deal with the modification of the front-end code only.

As it should become apparent by the descriptions of the present disclosure, the in-line editing insertions service described herein may work across various platforms and coding languages of the application. Unlike various other in-line editing applications where the in-line solution is fixed to that particular application, the presently described solutions may analyze and modify applications that use various coding languages and platforms. As long as the in-line editing service described herein can understand some basic tags (e.g., HTML tags, CSS selectors) of the front-end pages and back-end editing pages (e.g., as described above), and as long as the existing application can process cross-platform code such a JavaScript, REST, AJAX (more details provided below), the presently described solution may insert in-line editing functionality into the application. This offers significant benefits over any existing solutions.

Front-end code modifier 240 may include a front-end page marker 242, a page element marker 244, an editing interface inserter 246 and a content commit inserter 248. Each of these components and front-end code modifier 240 in general may each include instructions (e.g., stored on a machine-readable storage medium of system 200) that, when executed (e.g., by a processor of system 200), implement the functionality of the component. Alternatively or in addition, each of these components and front-end code modifier 240 in general may include electronic circuitry (i.e., hardware) that implements the functionality of the component.

Front-end page marker 242 may, for each front-end page that was selected as being in-line editable (see above), ensure that the front-end page is marked or identified as being of an appropriate page type. As described above, front-end page selector 222 or the developer via front-end page selector 222 may try to save an indicator of the selected page that already exists (e.g., an existing portion of the URL, an existing HTML tag, etc.). Alternatively, front-end page selector 222 may create an identifier and save it. Then, front-end page marker 242 may modify the front-end page to add the created identifier. For example, front-end page marker 242 may insert an HTML tag into the front-end code, or front-end page marker 242 may change the URL of the page to include an extension that identifies the page type. If the URL of the front-end page is changed, front-end page marker 242 may scan other portions of the application code to ensure that any portions that reference the front-end page URL instead reference the modified URL. If the front-end page does not need to be modified to insert a create identifier, front-end page marker 242 may still mark the front-end page generally as being in-line editable. This may be done by inserting an HTML tag or the like.

Page element marker 244 may, for each front-end page that is selected to be in-line editable, mark each page element as being in-line editable according to the selections made by the developer (e.g., via page element selector 226). To mark a page element as being in-line editable, page element marker 244 may modify the code of that front-end page to add an HTML tag (e.g., a “contenteditable” tag) to each page element that is to be in-line editable.

Editing interface inserter 246 may, for each page element that is to be in-line editable, modify the front-end code of that page to insert additional code (e.g., JavaScript code) that may be executed to display an in-line, front-end editing interface to a user. This inserted code may be referred to as “editing interface code.” Editing interface inserter 246 may refer to information collected by information collector 220 to determine what form the front-end editing interface should take. In particular, editing interface inserter 246 may look up the particular page element and then look up its corresponding back-end editing interface (e.g., as stored in Table 2 above). Then, editing interface inserter 246 may insert a front-end editing interface that is of a similar type to the back-end editing interface. For example, if the back-end editing interface is a text editor, editing interface inserter 246 may insert a text editor interface in the front-end code. Likewise, if the back-end editing interface is an image editor (e.g., a drop down selector to select from a number of preselected images, or a file selector that allows a user to select a new image) editing interface inserter 246 may insert an image editor interface in the front-end code. Thus, once editing interface inserter 246 has modified the code of a particular front-end page, all page elements of that page that were selected to be in-line editable may have corresponding code capable of displaying a front-end editing interface that corresponds to the associated back-end editing interface.

Editing interface inserter 246 may also insert code (e.g., JavaScript code) that provides a manner for activating the front-end in-line editing interfaces that were added. This inserted code may be referred to as “in-line editing activation code.” For example, for a particular page, each in-line editable page element may now display an icon or link of sorts that launches the front-end editing interface. As another example, for a particular page, the entire page may include a common icon, link, toolbar or the like that launches the front-end editing interfaces of all the in-line editable elements of the page. As yet another example, a portion of the page with multiple in-line editable page element within the portion may include a common icon, link, toolbar or the like, and other portions of the page may include separate icons, links, toolbars of the like that activate jus the in-line editable page elements of that portion.

Content commit inserter 248 may, for each page element that is to be in-line editable, modify the front-end code of that page to insert additional code (e.g., JavaScript, REST, AJAX) that may be executed to commit any changes provided via the front-end editing interfaces. This inserted additional code may be referred to as “content commit code.” For each in-line editable page element, content commit inserter 248 may add code that sends updated information to the corresponding back-end editing page, and also to the corresponding back-end editing interface. Content commit inserter 248 may refer to information collected by information collector 220 to determine what back-end editing page corresponds to the particular front-end page, and to determine what back-end editing interface coresponds to each front-end page element.

As one example, assume a blogging front-end page like the first row of Table 1. Additionally, assume a body page element of that front-end page, like shown in the first row of Table 2. Then, content commit inserter 248 may insert code for the body page element that makes a call (e.g., REST call) to the corresponding back-end editing page (app/blog_post/[particular blog post]/edit) shown in Table 1, where the call also indicates the appropriate back-end editing interface (edit_body) that corresponds to the body page element as shown in Table 2. As described above, the back-end editing page could be referenced using a URL convention or an HTML tag convention or the like. Likewise, the back-end editing interface could be indicated using a CSS selector, cookie or the like. When this code executes in actual use (real user), the [particular blog post] placeholder will reference an actual piece of content such as “blog_post_1”. Thus, in this example, the code inserted by content commit inserter 248 would indicate to the back-end editing page that the body of blog_post_1 should be updated.

Content commit inserter 248 may, after initiating a call to a back-end editing page to update information from the front-end page, listen for an indication that the updated information has been successfully processed by the back-end editing interface. For example, content commit inserter 248 may listen for a “200” status code in response to a REST call to the back-end editing page. In some examples, a “success” message may be displayed to the user on the front-end page, e.g., using AJAX. AJAX may also be used to update the front-end page (i.e., updated page elements) with the new/updated information submitted via the added in-line editing functionality. Such code to update the front-end page may be referred to as “local update code.”

Once front-end code modifier 240 finishes modifying the original/existing application code, and outputs modified front-end code 206, a new code base for a modified application may be created, e.g., using the original back-end code 202 and modified front-end code 206. This modified code base may be provided as part of a modified application, e.g., that may be executed by a user's web browser in the example of a web application.

When a user executes the modified application, and navigates to a front-end page that was selected to be in-line editable, new code inserted by editing interface inserter 246 may allow the user to activate in-line editing for selected page elements. When a user activates in-line editing, depending on the design, editing interfaces may appear on the screen or in pop-up windows, or the like. In one example, once in-line editing is activated, the original front-end page content may all be displayed on one side (e.g., right) of the screen, and all the appropriate in-line editing interfaces may appear on the other side (e.g., left) of the screen, next to the corresponding page element. Various other designs of how the in-line editing interfaces may be presented to users are contemplated by this disclosure, and the precise design and functionality may be established by the code inserted by editing interface inserter 246. Once a user modifies the desired front-end page content, the user may indicate (e.g., via a “save” button or the like that is part of the front-end editing interface) that the changes should be committed. Then, code inserted by content commit inserter may execute to commit the changes as described above.

In some examples, front-end code modifier 240 may modify the original/existing application code to insert additional code that manages privileges (e.g., user authentication, privileged content and actions, etc.) This additional code may be inserted by editing interface inserter 246 or by another component of front-end code modifier 240. This additional code may include, for example, a way to detect whether a current user is privileged (e.g., logged in). The user may have, for example, logged in via some other login page and some indication of that login was saved (e.g., by the web browser). The additional code may include a way for the current front-end page to access this indication of a login, e.g., using an HTML tag, cookie with a specific name, CSS class or the like. Furthermore, this additional code may activate the in-line editing interfaces described above, upon detecting that the user has appropriate permissions (e.g., is logged in). For example, JavaScript can be used to perform such activation based on an indication of privilege.

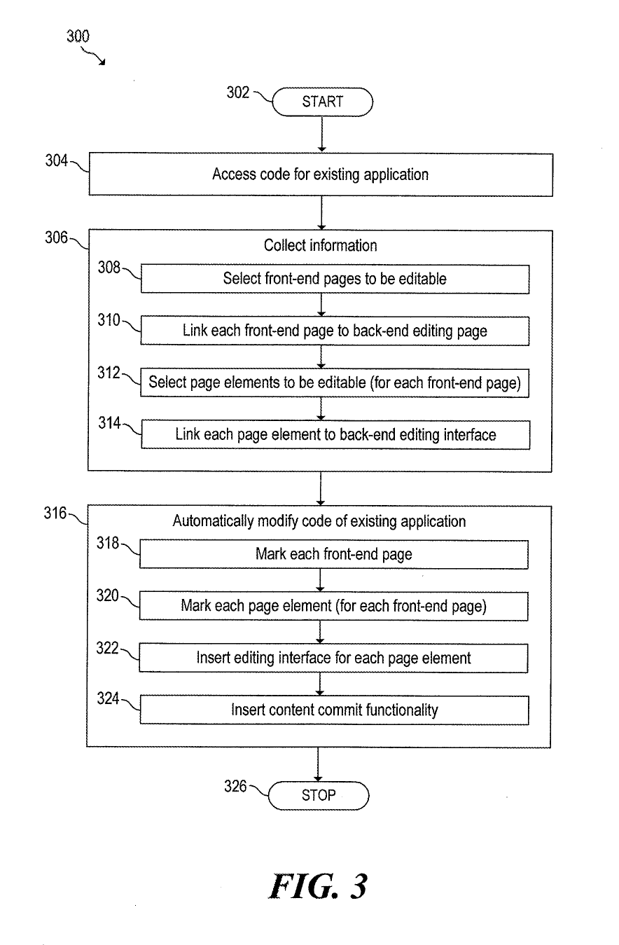

FIG. 3 is a flowchart of an example method 300 for in-line editor insertion. Method 300 may be described below as being executed or performed by a system, for example, system 200 of FIG. 2. Other suitable systems and/or computing devices may be used as well. Method 300 may be implemented in the form of executable instructions stored on at least one machine-readable storage medium of the system and executed by at least one processor of the system. Alternatively or in addition, method 300 may be implemented in the form of electronic circuitry (e.g., hardware). In alternate embodiments of the present disclosure, one or more steps of method 300 may be executed substantially concurrently or in a different order than shown in FIG. 3. In alternate embodiments of the present disclosure, method 300 may include more or less steps than are shown in FIG. 3. In some embodiments, one or more of the steps of method 300 may, at certain times, be ongoing and/or may repeat.

Method 300 may start at step 302 and continue to step 304, where an in-line editor insertion service (e.g., 210 of FIG. 2) of the system may access code (e.g., back-end code 202 and front-end code 204) for an existing application. At step 306, the in-line editor insertion service may collect (e.g., via information collector 220) information by accessing or prompting for various pieces of information from a developer, as described in more detail above. These pieces of information may be saved and used later, e.g., by front-end code modifier 240. Step 306 may include a number of sub-steps (308, 310, 312, 314), which may simply be referred to as steps. At step 308, the in-line editor insertion service may select (e.g., via front-end page selector 222) front-end pages to be editable, as described in more detail above. At step 310, the in-line editor insertion service may link (e.g., via back-end page linker 224) each front-end page to an appropriate back-end editing page, as described in more detail above. At step 312, the in-line editor insertion service may, for each front-end page that was selected to be editable, select (e.g., via page element selector 226) page elements in that page to be editable, as described in more detail above. At step 314, the in-line editor insertion service may link (e.g., via editing interface linker 228) each page element to an appropriate back-end editing interface of the associated back-end editing page, as described in more detail above.

At step 316, the in-line editor insertion service may automatically modify (e.g., via front-end code modifier 240) the code of the existing application, as described in more detail above. Various examples provided herein describe the in-line editor insertion service as modifying only the front-end code, which may offer various benefits. However, some examples of the present disclosure contemplate editing the back-end code as well. Step 316 may include a number of sub-steps (318, 320, 322, 324), which may simply be referred to as steps. At step 318, the in-line editor insertion service may mark (e.g., via front-end page marker 242) each front-end page (e.g., based on information collected at step 308), as described in more detail above. At step 320, the in-line editor insertion service may, for each front-end page that is to be editable, mark (e.g., via page element marker 244) each page (e.g., based on information collected at step 310) element that it to be editable, as described in more detail above. At step 322, the in-line editor insertion service may insert (e.g., via editing interface inserter 246) a front-end editing interface for each page element that is to be editable, as described in more detail above. At step 324, the in-line editor insertion service may insert (e.g., via content commit inserter 248) content commit functionality, as described in more detail above. For example, content commit code may be inserted for an entire page or for each individual page element that is to be editable. Method 300 may eventually continue to step 326, where method 300 may stop.

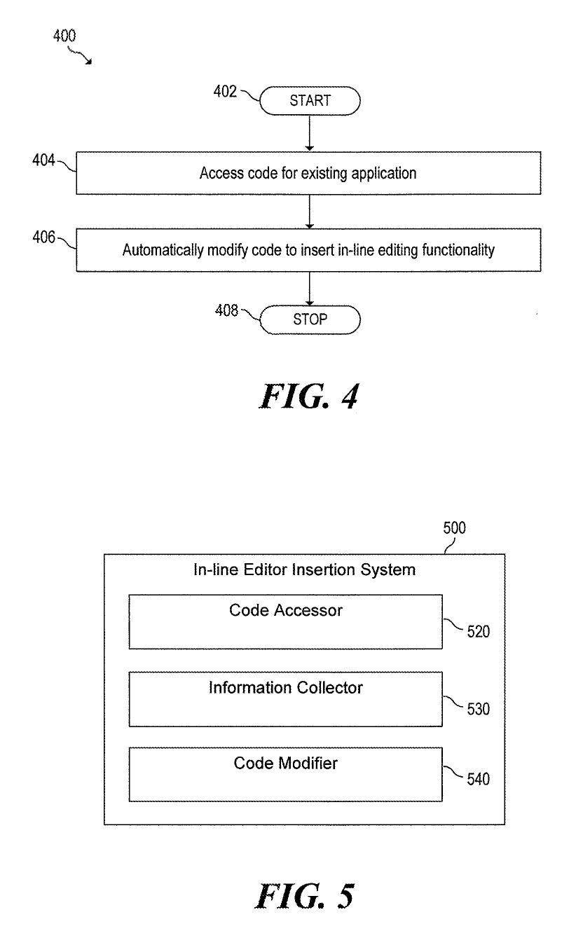

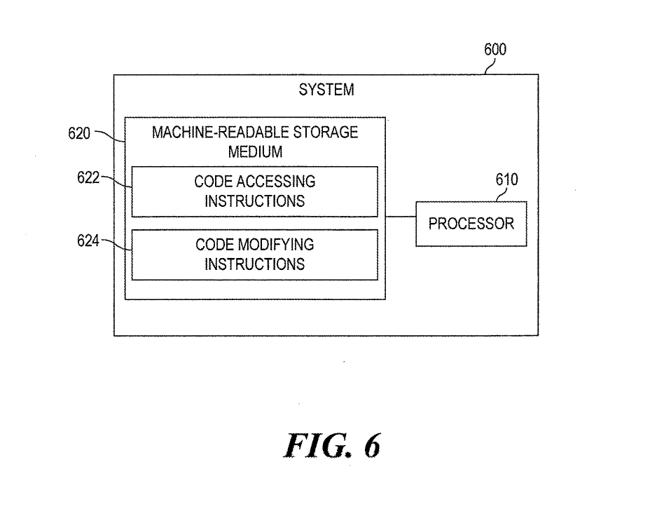

FIG. 4 is a flowchart of an example method 400 for in-line editor insertion. Method 400 may be described below as being executed or performed by a system, for example, system 500 of FIG. 5 or system 600 of FIG. 6. Other suitable systems and/or computing devices may be used as well, e.g., system 200 of FIG. 2. Method 400 may be implemented in the form of executable instructions stored on at least one machine-readable storage medium of the system and executed by at least one processor of the system. Alternatively or in addition, method 400 may be implemented in the form of electronic circuitry (e.g., hardware). In alternate embodiments of the present disclosure, one or more steps of method 400 may be executed substantially concurrently or in a different order than shown in FIG. 4. In alternate embodiments of the present disclosure, method 400 may include more or less steps than are shown in FIG. 4. In some embodiments, one or more of the steps of method 400 may, at certain times, be ongoing and/or may repeat.

Method 400 may start at step 402 and continue to step 404, where the system may access code for an application that is capable of presenting a front-end page to a user, where content on the front-end page is editable via a back-end editing page. At step 406, the system may automatically modify the code to create a modified application that is capable of presenting a modified front-end page to the user that is similar to the front-end page and where content on the modified front-end page is editable in-line via the modified front-end page. Thus, at step 406, the system inserts in-line editing functionality into the existing application. Method 400 may eventually continue to step 408, where method 400 may stop.

FIG. 5 is a block diagram of an example system 500 for in-line editor insertion. System 500 may be similar to system 200 of FIG. 2, for example. In the embodiment of FIG. 5, system 500 includes a code accessor 520, an information collector 530 and a code modifier 540. Code accessor 520 may access code for an application that is capable of presenting a front-end page to a user, where content on the front-end page is editable via a back-end editing page. Code accessor 520 may be implemented in the form of executable instructions stored on at least one machine-readable storage medium of system 500 and executed by at least one processor of system 500. Alternatively or in addition, code accessor 520 may be implemented in the form of one or more hardware devices including electronic circuitry for implementing the functionality of code accessor 520.

Information collector 530 may be similar to information collector 220 of FIG. 2, for example. Information collector 530 may access information provided by user selection or a configuration file. The information may indicate a connection between a page element of the front-end page that is to be in-line editable and a corresponding editing interface of the back-end editing page. Information collector 530 may be implemented in the form of executable instructions stored on at least one machine-readable storage medium of system 500 and executed by at least one processor of system 500. Alternatively or in addition, information collector 530 may be implemented in the form of one or more hardware devices including electronic circuitry for implementing the functionality of information collector 530.

Code modifier 540 may be similar to front-end code modifier 240 of FIG. 2, for example. Code modifier 540 may automatically modifying the code of the application to create a modified application that is capable of presenting a modified front-end page to the user that is similar to the front-end page and where content on the modified front-end page is made editable in-line via the modified front-end page using the information indicating a connection. Code modifier 540 may be implemented in the form of executable instructions stored on at least one machine-readable storage medium of system 500 and executed by at least one processor of system 500. Alternatively or in addition, code modifier 540 may be implemented in the form of one or more hardware devices including electronic circuitry for implementing the functionality of code modifier 540.

FIG. 6 is a block diagram of an example system 600 for in-line editor insertion. System 600 may be similar to system 200 of FIG. 2, for example. In the embodiment of FIG. 6, system 600 includes a processor 610 and a machine-readable storage medium 620. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 610 may be one or more central processing units (CPUs), microprocessors, and/or other hardware devices suitable for retrieval and execution of instructions stored in machine-readable storage medium 620. In the particular embodiment shown in FIG. 6, processor 610 may fetch, decode, and execute instructions 622, 624 to perform in-line editor insertion. As an alternative or in addition to retrieving and executing instructions, processor 610 may include one or more electronic circuits comprising a number of electronic components for performing the functionality of one or more of the instructions in machine-readable storage medium 620. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium. In this situation, the executable instructions may be part of an “installation package”. As described herein, machine-readable storage medium 620 may be encoded with executable instructions for in-line editor insertion.

Referring to FIG. 6, code accessing instructions 622, when executed by a processor (e.g., 610), may cause system 600 to access code for an application that is capable of presenting a front-end page to a user, where content on the front-end page is editable via a back-end editing page. Code modifying instructions 622, when executed by a processor (e.g., 610), may cause system 600 to automatically modify the code to create a modified application that is capable of presenting a modified front-end page to the user that is similar to the front-end page and where content on the modified front-end page is editable in-line via the modified front-end page. Automatically modifying the code may include inserting into the code of the application, for at least one page element of the front-end page that is to be in-line editable, code that is capable of displaying an editing interface for the page element on the front-end page and sending modified information for the page element to a corresponding editing interface of the back-end editing page.

1. A method for in-line editor insertion, the method comprising:
accessing code for an application that is capable of presenting a front-end page to a user, where content on the front-end page is editable via a back-end editing page; and
automatically modifying the code to create a modified application that is capable of presenting a modified front-end page to the user that is similar to the front-end page and where content on the modified front-end page is editable in-line via the modified front-end page.

2. The method of claim 1, wherein automatically modifying the code includes:
identifying at least one page element of the front-end page that is to be in-line editable; and
inserting into the code of the application, for each page element that is to be in-line editable, editing interface code that is capable of displaying an editing interface for the page element on the front-end page.

3. The method of claim 2, wherein automatically modifying the code further includes determining, for each page element that is to be in-line editable, the form of the editing interface by looking up a corresponding back-end editing interface of the back-end editing page and using a similar form.

4. The method of claim 3, wherein a connection between each page element that is to be in-line editable and the corresponding back-end editing interface is established based on user selection or a configuration file.

5. The method of claim 4, wherein the connection includes:
identifying each page element using an HTML tag or CSS selector; and
identifying each corresponding back-end editing interface using an HTML tag or CSS selector.

6. The method of claim 4, wherein a connection between the front-end page and the corresponding back-end editing page is established based on user selection or a configuration file, wherein the connection includes:
identifying the front-end page using a URL, URL extension, HTML tag or CSS selector of the front-end page; and
identifying the corresponding back-end editing page using a URL, URL extension, HTML tag or CSS selector of the front-end page.

7. The method of claim 2, wherein automatically modifying the code further includes inserting, into the code of the application, in-line editing activation code that is capable of displaying an icon, link or toolbar that allows a user to engage with it to cause at least one of the editing interfaces to display or activate.

8. The method of claim 2, wherein automatically modifying the code further includes inserting, into the code of the application, content commit code that, for each editing interface, is capable of sending a request with updated information from the editing interface to the back-end editing page and the corresponding back-end editing interface to save the updated information.

9. The method of claim 8, wherein a connection between the front-end page and the back-end editing page is established based on user selection or a configuration file, and wherein a connection between each editing interface and the corresponding back-end editing interface is established based on user selection or a configuration file.

10. The method of claim 8, wherein automatically modifying the code further includes inserting, into the code of the application, local update code that, for any updated information sent by any of the editing interfaces to the back-end editing page, is also updated on the front-end page.

11. A system for in-line editor insertion, the system comprising:
a code accessor to access code for an application that is capable of presenting a front-end page to a user, where content on the front-end page is editable via a back-end editing page;
an information collector to access information provided by user selection or a configuration file, the information indicating a connection between a page element of the front-end page that is to be in-line editable and a corresponding editing interface of the back-end editing page; and
a code modifier to automatically modifying the code of the application to create a modified application that is capable of presenting a modified front-end page to the user that is similar to the front-end page and where content on the modified front-end page is made editable in-line via the modified front-end page using the information indicating a connection.

12. The system of claim 11, wherein content on the modified front-end page is made editable in-line by inserting into the code of the application code that is capable of displaying an editing interface for the front-end page element and sending modified information from the editing interface for the front-end page element to the corresponding editing interface of the back-end editing page.

13. The system of claim 12, wherein the code modifier is further to determine the form of the editing interface for the front-end page element by looking up the corresponding editing interface of the back-end editing page and using a similar form.

14. A machine-readable storage medium encoded with instructions for in-line editor insertion, the instructions executable by a processor of a system to cause the system to:
access code for an application that is capable of presenting a front-end page to a user, where content on the front-end page is editable via a back-end editing page; and
automatically modify the code to create a modified application that is capable of presenting a modified front-end page to the user that is similar to the front-end page and where content on the modified front-end page is editable in-line via the modified front-end page,
wherein automatically modifying the code includes inserting into the code of the application, for at least one page element of the front-end page that is to be in-line editable, code that is capable of displaying an editing interface for the page element on the front-end page and sending modified information for the page element to a corresponding editing interface of the back-end editing page.

15. The machine-readable storage medium of claim 14, wherein the instructions executable by the processor of the system further cause the system to collect information that establishes a connection, for the at least one page element of the front-end page that is to be in-line editable, between the page element and the corresponding back-end editing interface, identifying the page element using an HTML tag or CSS selector and identifying the corresponding back-end editing interface using an HTML tag or CSS selector.
